(19) United States
(12) Patent Application Publication
(10) Pub. No.: US 2007/0063649 A1
(43) Pub. Date: Mar. 22, 2007

(54) Flexible mold and production method thereof, as well as back surface plate for pdp and production method thereof

(76) Inventors: Akira Yoda, Tokyo (JP); Hiroshi Kikuchi, Kanagawa Pref (JP); Chikafumi Yokoyama, Kanagawa (JP); Takaki Sugimoto, Tokyo (JP)

Correspondence Address: 3M INNOVATIVE PROPERTIES COMPANY, PO BOX 33427, ST. PAUL, MN, 55133-3427, US

(21) Appl. No.: 10/538,450

(22) PCT Filed: Dec. 15, 2003
(86) PCT No.: PCT/US03/39866

§ 371 Date: Dec. 16, 2005

(30) Foreign Application Priority Data
Jan. 8, 2003 (JP) 2003039866

(51) Int. Cl. H01J 17/49

(52) U.S. Cl. 313/582

(57) ABSTRACT

In a PDP back surface plate comprising substrate and a rib pattern layer formed on the substrate and having a rib region that has ribs having a predetermined shape and a predetermined size, and a non-rib region that occupies at least a part of a peripheral portion of the rib region, a thin film made of the same material as that of the ribs is formed to a predetermined thickness in the non-rib region.

### FIELD OF THE INVENTION

This invention relates to a constituent element of a plasma display panel and its production method. More particularly, the invention relates to a plasma display panel back surface plate and its production method, and a flexible mold useful for producing the back surface plate and its production method.

### BACKGROUND OF THE INVENTION

It is well known that display apparatuses of a cathode ray tube (CRT) have economically been mass-produced with development and progress of television technologies. In recent years, however, a flat display panel that is thin and light in weight has drawn an increasing attention as a display apparatus of a next generation to replace the CRT display apparatuses.

One of the typical flat displays is a liquid crystal display (LCD). The LCD has already been employed as a compact display apparatus of notebook type personal computers, cellular telephone sets, personal digital assistants (PDA) or other mobile electronic information appliances. On the other hand, a typical example of the thin, large-scale flat panel display is a plasma display panel (PDP). The use of the PDP has been started for a wall-hung television unit for business or home use.

The PDP has a construction schematically shown in FIG. 1. Incidentally, the PDP 70 has only one discharge display cell 56 in the example shown in the drawing to simplify illustration, but generally contains a large number of very small discharge display cells. More in detail, each discharge display cell 56 includes a pair of glass substrates that are so spaced apart to oppose each other, that is, a front surface glass substrate 61 and a back surface glass substrate 51, and ribs (also called “barrier ribs”, “partitions” or “barriers”) arranged with a predetermined spacing between these glass substrates. The front surface glass substrate 61 includes transparent display electrodes 63 each consisting of a scanning electrode and holding electrode, a transparent dielectric layer 62 and a transparent protective layer 64. The back surface glass substrate 51 includes thereon address electrodes 53 and a dielectric layer 52. The display electrode 63 consisting of the scanning electrode and the holding electrode crosses the address electrode 53, and these electrodes 63 and 53 are arranged in a predetermined pattern with spacing between them. Each discharge display cell 56 has on its inner wall a phosphor layer 55, and a rare gas (such as Ne—Xe gas) is sealed therein. The discharge display cell 56 can execute spontaneous light display due to plasma discharge between the electrodes.

Generally, a rib 54 is formed of a fine structure of ceramic. As schematically shown in FIG. 2, the ribs 54 are arranged in advance with the address electrodes 53 on the back surface of glass substrate 51 and constitute the PDP back surface plate 50. As schematically shown in FIG. 3, the PDP back surface plate 50 is generally composed of a rib region 36 occupying a center portion and a non-rib region 38 encompassing the periphery of the rib region 36. In the rib region 36 shown in the drawing are arranged a large number of ribs in a straight pattern as shown in FIG. 2. These ribs do not extend to the non-rib region 38. For, the non-rib region 38 is utilized to connect the electrodes of the back surface plate 50 to devices or to apply a sealant when the back surface plate 50 is superposed and sealed with the front surface plate (front surface glass substrate) in a subsequent step. The width w of the non-rib region 38 is generally several centimeters.

Accuracy of the shape and size of the ribs of the PDP back surface plate greatly affects performance of the PDP. Therefore, various improvements have so far been made to a mold used for producing the ribs and to their production methods. For example, a method of forming partitions has already been proposed (Japanese Unexamined Patent Publication (Kokai) No. 9-12336) that involves the steps of using a metal or glass for a mold material, arranging a coating solution for forming ribs (partitions) between a surface of a glass substrate and the mold material, removing the mold material after the coating solution is cured, and firing the substrate to which the cured coating solution is transferred. In this method, the coating solution contains low melting point glass powder as its main component. A method of producing a PDP substrate has also been proposed that involves the steps of filling a mixture of ceramic or glass powder with a binder of an organic additive into a silicone resin mold having recesses for partitions, and bonding and integrating the mixture to a back surface plate formed of ceramic or glass (Japanese Unexamined Patent Publication (Kokai)No. 9-134676). Further, a method of forming partitions has been proposed that involves the steps of forming partition members having predetermined softness to a predetermined thickness in a planar shape on a surface of a substrate, press-molding partition members by use of a press mold having a shape corresponding to the partitions to be formed, releasing the press mold from the partition members and heat-treating the partition members after molding at a predetermined temperature (Japanese Unexamined Patent Publication (Kokai)No. 9-283017).

The conventional PDP back surface plate explained with reference to FIGS. 2 and 3 has often been produced in a system that provides a large number of back surface plates. In other words, to improve production efficiency and to lower the production cost, a plurality of PDP back surface plates 50 are simultaneously produced from a sheet-like substrate as schematically shown in FIG. 4, and the discrete back surface plates 50 are then cut away along cut lines C. However, this production method involves a complicated operation of forming the ribs on the entire surface of the substrate so as to form the non-rib regions 38-1 and 38-2 at both end portions and then cuts off the ribs of the unnecessary portions by using a razor blade. Such a troublesome operation is also necessary when forming the non-rib region 38-3 between adjacent rib regions 36.

According to this method, breakage of the substrates and the ribs often occurs when the PDP back surface plate is withdrawn from the mold, and the mold itself is sometimes broken. The problem of breakage lowers the production yield of the product and hinders mass-production.

To address such problem, a production method of a PDP back surface plate, as will be explained with reference to FIGS. 5 and 6, was developed. According to this production method,
(1) a glass substrate used as a substrate of a back surface plate;
(2) a rib precursor containing a first photo-curing initiator having a first absorption end capable of absorbing the rays of light having a long wavelength of about 400 nm or more, for example, a first photo-curable component such as an acrylic or methacyrlic photo-curable resin and glass or ceramic powder; and
(3) a transparent flexible mold obtained by photo-curing a second photo-curable component of an acrylic or methacrylic type in the presence of a second photo-curing initiator having a second absorption end having a shorter wavelength than that of the first absorption end of the first photo-curing initiator, that is, an initiator capable of substantially absorbing the rays of light of a wavelength shorter than about 400 nm; are prepared.

First, a predetermined amount of the rib precursor 33 is filled between the glass substrate 31 and the mold 10 as shown in FIG. 5(A). Incidentally, the groove pattern for forming the ribs that should exist on the surface of the mold 10 is omitted from the drawing for simplifying the explanation.

Next, the mold 10 is carefully superposed as shown in FIG. 5(B) so that the rib precursor 33 on the glass substrate 31 uniformly spreads. The glass substrate 31 can be divided into the rib region 36 on which the ribs are to be formed and the non-rib region 38 where the formation of the ribs is not necessary, as explained previously with reference to FIG. 3.

After the mold 10 is put on the glass substrate 31, a shading mask 40 having a pattern corresponding to the rib region 36 is put on the mold 10 as shown in FIG. 5(C). Next, the rays of light having a wavelength shorter than about 400 nm are irradiated to the rib precursor 33 through the mold 10 in the presence of the shading mask 40. Due to this exposure, only the rib precursor 33 of the non-rib region 38 is selectively photo-cured.

After the shading mask 40 is removed from the mold 10, the rays of light having a wavelength shorter than about 400 to about 500 nm are irradiated to the glass substrate 31 and to the rib precursor 33 from both sides as shown in FIG. 6(D). Due to this exposure, only the rib precursor 33 of the rib region is selectively photo-cured.

Finally, as shown in FIG. 6(E), the mold 10 is removed from the glass substrate 31. The cured rib precursor 34 remains in the rib form on the rib region 36. Therefore, the intended PDP back surface plate 50 having the ribs can be acquired. The cured rib precursor 34 in the non-rib region 38 is peeled and removed while it is bonded to the mold 10. The reason why the cured rib precursor 34 of the non-rib region 38 can be removed from the glass substrate 31 is because the non-reacted second curing component contained in the mold 10 and the first curing component in the rib precursor 33 cause the photo-curing reaction and the cured rib precursor 34 is fixed to the mold 10. The separation surface of the rib precursor 34 is substantially perpendicular as shown in the drawing. Incidentally, when a certain amount of the rib precursor or its cured product remains in the non-rib region 38 of the glass substrate 31, it must be removed by using a scraper. In this case, however, electrode terminals that have already been formed in the non-rib region 38 may be damaged.

In the production method of the PDP back surface plate, the problem shown in FIGS. 7 and 8 may occur. That is, it is difficult to clearly separate the cured rib precursor (rib) 34 in the interface between the rib region 36 and the non-rib region 38 and breakage occurs in some cases. Therefore, the end portion of the rib 34 creates rugged surface x, and fragments 34y of the rib scatter. When the fragments 34y fall on the rib region 36, adverse influences are exerted on the display effect. According to the production method described above, the rib 34 undergoes shrinkage. Therefore, the end portion of the rib 34 turns up as shown in FIG. 8, thereby forming a gap 34g and lowering durability of the panel.

### SUMMARY OF THE INVENTION

According to one aspect of the invention, there is provided a flexible mold for producing a PDP back surface plate including a rib region having ribs having a predetermined shape and a predetermined size and a non-rib region occupying at least a part of a peripheral portion of the rib region, comprising a support and a molding layer disposed on the support, wherein the molding layer is equipped on a surface thereof with groove patterns necessary for duplicating ribs having a predetermined shape and a predetermined size in a rib formation portion corresponding to the rib region of the back surface plate, and in a rib non-formation portion corresponding to a non-rib region of the back surface plate, the molding layer is formed to a thickness necessary for forming a thin film made of the same material as that of the ribs in the rib non-formation region.

According to another aspect of the invention, there is provided a method of producing a flexible mold for producing a PDP back surface plate including a rib region having ribs having a predetermined shape and a predetermined size and a non-rib region occupying at least a part of a peripheral portion of said rib region, the method comprising the steps of preparing a mold duplicating a surface shape of the PDP back surface plate; applying a photo-curable material at a predetermined thickness to a surface of the mold, thereby forming a photo-curable material layer; further laminating a transparent support made of a plastic material on the photo-curable material layer of the mold, thereby forming a laminate body of the mold, the photo-curable material layer and the support; irradiating light from the side of the support to the laminate body, thereby curing the photo-curable material layer; forming a transparent molding layer equipped on a surface thereof with groove patterns necessary for duplicating ribs in a rib formation portion corresponding to the rib region of the back surface plate by curing of the photo-curable material layer, and formed, in a rib non-formation portion thereof corresponding to a non-rib region of the back surface plate, to a thickness necessary for forming a thin film made of the same material as that of the ribs in the rib non-formation region; and releasing the molding layer with the support supporting the molding layer from the mold.

According to still another aspect of the invention, there is provided a PDP back surface plate comprising a substrate having formed thereon a rib pattern layer having a rib region having ribs having a predetermined shape and a predetermined size and a non-rib region occupying at least a part of a peripheral portion of the rib region, wherein a thin film made of the same material as that of the ribs is formed to a predetermined thickness in the non-rib region.

According to still another aspect of the invention, there is provided a method of producing a flexible mold for producing a PDP back surface plate comprising a substrate having formed thereon a rib pattern layer including a rib region having ribs having a predetermined shape and a predetermined size and a non-rib region occupying at least a part of a peripheral portion of the rib region, the method comprising the steps of producing a flexible mold in accordance with the method of the invention; arranging a curable molding material between the substrate and a molding layer of the mold, thereby filling the molding material into groove patterns of a rib formation portion of the mold and applying it to a predetermined thickness to a rib non-formation portion; curing said molding material, thereby forming a PDP back surface plate comprising a substrate having formed thereon a rib pattern layer including a rib region having ribs having a predetermined shape and a predetermined size and a non-rib region occupying at least a part of a peripheral portion of the rib region, the back surface plate further including a thin film formed of the same material as that of the ribs to a predetermined thickness in the non-rib region; and removing the back surface plate from the mold.

The invention can advantageously provide a flexible mold that is useful for producing a PDP back surface plate, and can arrange ribs easily and accurately with high dimensional accuracy at predetermined positions without calling for a high level of skill for the production. As another advantage, the invention can provide a flexible mold that can produce a PDP back surface plate without causing turn-up and fragments of ribs, can easily form a non-rib region and is moreover free from the problem of disconnection of electrodes in the non-rib region.

### BRIEF DESCRIPTION OF THE DRAWINGS

FIG. 1 is a sectional view schematically showing an example of a PDP of the prior art to which the invention can also be applied.

FIG. 2 is a perspective view showing a PDP back surface plate used for the PDP shown in FIG. 1.

FIG. 3 is a plan view schematically showing the existence of a rib region and a non-rib region in a PDP back surface plate.

FIG. 4 is a plan view schematically showing a method of collectively producing PDP back surface plates shown in FIG. 3.

FIGS. 5A-5C is a sectional view schematically showing a method of producing a PDP back surface plate.

FIGS. 6D-6E is a sectional view schematically showing a method of producing a PDP back surface plate.

FIG. 7 is a sectional view schematically showing one of the problems that may occur in the production method of the PDP back surface plate shown in FIGS. 5 and 6.

FIG. 8 is a sectional view schematically showing another problem that may occur in the production method of the PDP back surface plate shown in FIGS. 5 and 6.

FIG. 9 is a sectional view showing a form of a flexible mold according to the invention.

FIG. 10 is a perspective view showing a form of a PDP back surface plate according to the invention.

FIG. 11 is a sectional view of the PDP back surface plate shown in FIG. 10 and taken along a line XI-XI.

FIGS. 12A-12C is a sectional view serially showing a production method of a PDP back surface plate according to the invention.

FIGS. 13A-13C is a sectional view serially showing a production method of a flexible mold according to the invention.

FIGS. 14A-14C is a sectional view serially showing a production method of a PDP back surface plate by use of the flexible mold shown in FIG. 13.

FIG. 15 is a sectional view showing another form of a mold according to the invention.

FIGS. 16A-16B is a sectional view showing a PDP back surface plate (portion) produced by use of the mold shown in FIG. 15.

### DETAILED DESCRIPTION OF THE PREFERRED EMBODIMENTS

A flexible mold and a production method thereof, and a PDP back surface plate and a production method thereof, according to the invention can be advantageously carried out in various embodiments, respectively. As has already been explained with reference to FIG. 2, the ribs 54 of the PDP are arranged on the back surface glass substrate 51 and constitute the PDP back surface plate. The gap of the ribs 54 (cell pitch) changes with a screen size but is generally within the range of about 150 to about 400 μm. Generally, the ribs must be “free from defects such as admixture of bubbles and deformation” and must have “high pitch accuracy”. As to pitch accuracy, the ribs must be arranged at predetermined positions with hardly any error with respect to the address electrodes, and a positioning error of only within dozens of μm is permitted in practice. When the positioning error exceeds dozens of μm, adverse influences are exerted on the emission condition of visible light, and satisfactory spontaneous display becomes impossible. Because the screen size has become greater and greater at present, the problem of such pitch accuracy of the ribs is a critical problem to be solved.

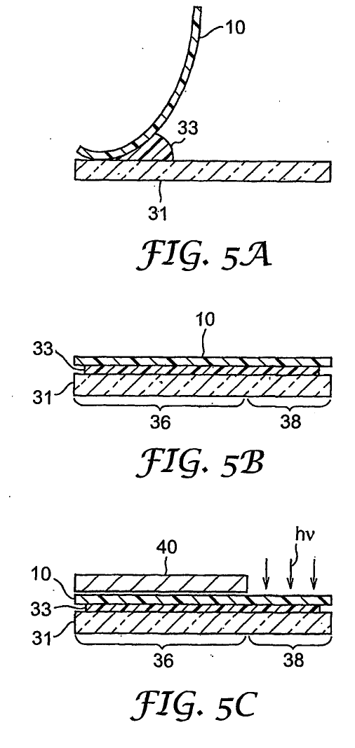

When the ribs 54 are viewed as a whole, the total pitch of the ribs 54 (distance between the ribs at both ends; though FIG. 5 shows only five ribs, generally about 3,000 ribs are arranged) must generally have dimensional accuracy of dozens of ppm. It is generally advantageous to shape the ribs by use of a flexible mold generally including a support and a molding layer having groove patterns and supported by the support. In such a molding method, however, the total pitch (distance between the grooves at both ends) must have dimensional accuracy of not greater than dozens of ppm in the same way as the ribs. The present invention can produce both flexible mold and PDP back surface plate with high dimensional accuracy and with high production yield by use of the production method that will be explained hereinafter in detail.

The flexible mold according to the invention is specifically designed so as to produce a PDP back surface plate having a rib region and a non-rib region occupying at least a part of the peripheral portion of the rib region. If necessary, this mold may be applied to production of moldings other than the PDP back surface plate.

The flexible mold according to the invention is so constituted as to comprise at least a support and a molding layer disposed on the support. The molding layer ordinarily consists of a single layer but may have a multi-layered structure of two or more layers formed of materials having different properties and/or kinds. When the use of a photo-curable molding material is particularly taken into consideration, both of the support and the molding layer are preferably transparent.

The molding layer of the mold is so constituted as to include a rib formation portion corresponding to the rib region of the back surface plate and a rib non-formation portion corresponding to the non-rib region of the back surface plate. It is hereby of importance that the mold is so constituted as to include on its surface groove patterns necessary for duplicating ribs having a predetermined shape and a predetermined size, and to possess, in its rib non-formation region, a thickness necessary for forming a thin film made of the same material as the material of the ribs in the rib non-formation region of the back surface plate.

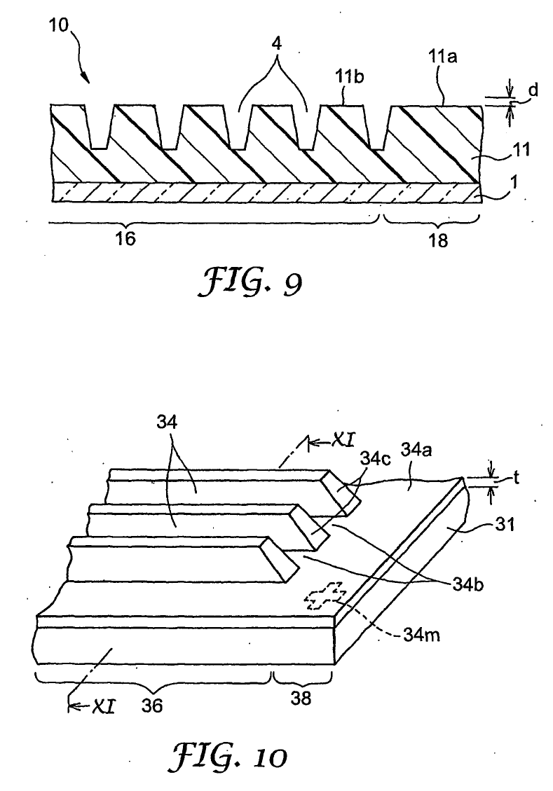

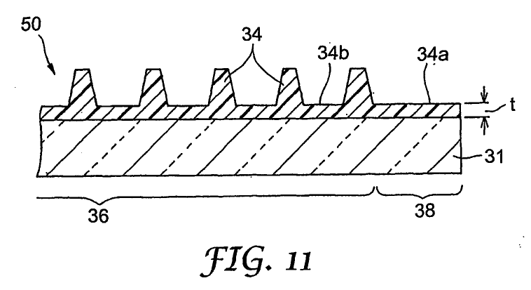

FIG. 9 is a sectional view schematically showing a flexible mold according to a preferred embodiment of the invention. As can be seen from the drawing, this flexible mold 10 is designed to produce a back surface glass substrate 31 having a straight rib pattern including a plurality of ribs 34 arranged in parallel with one another as will be explained hereinafter with reference to FIGS. 10 and 11. Incidentally, the design of this flexible mold 10 can be changed to a mold for producing a back surface glass substrate having a grid-like rib pattern in which a plurality of ribs is arranged substantially parallel while crossing one another with predetermined gaps among them, or to a mold for producing a back surface glass substrate having a meander rib pattern, though they are not shown in the drawings.

The molding layer 11 of the flexible mold 10 has a groove pattern having a predetermined shape and a predetermined size on the surface of its rib formation portion 16 as shown in the drawings. The groove pattern has a straight pattern having a plurality of grooves 4 arranged substantially parallel to one another with a predetermined gap among them. In the invention, the portion in the rib formation portion 16 that connects the grooves 4 with one another is particularly called “planar portions” 11b. The planar portion 11b is necessary when the thin film formed of the same material as that of the rib is formed to a predetermined thickness in the rib region of the back surface plate. The flexible mold 10 may have an additional layer or layers, whenever necessary, and an arbitrary treatment or processing may be applied to each layer constituting the mold. However, the flexible mold 10 basically comprises the support 1 and the molding layer 11 having the grooves 4 and arranged on the support 1 as shown in FIG. 9.

In the case of the mold 10 shown in the drawing, the molding layer 11 has the same thickness in both rib non-formation portion 18 and the rib formation portion 16 (planar portion 11b). However, the thickness of the planar portion 11b of the molding layer 11 may be either smaller or greater than the thickness of the molding layer 11a of the rib formation portion 16, whenever necessary. Preferably, the thickness of the molding layer 11a of the rib non-formation portion 18 is smaller by a depth d than the thickness of the rib formation portion 16, though it is not shown in the drawings. Here, the depth d can be arbitrarily changed in accordance with the thickness of the rib pattern layer of the rib non-formation region of the PDP back surface plate to be produced, but is generally at least about 5 μm, preferably from about 5 to 20 μm and is further preferably within the range of from about 10 to about 15 μm. According to this construction of the molding layer 11, when the thin film is formed in the rib non-formation region of the resulting back surface plate, the invention can acquire two effects, that is, protection of the electrodes and saving of the rib material. As to the electrodes not requiring protection, the effect of the invention can be exhibited when the thickness of the resulting thin film is so controlled as to approach zero.

In the rib formation portion 16 of the molding layer 11, each of the grooves 4 formed in this portion 16 preferably has inclination at its terminal portion. For, when the inclination exists, the ribs of the back surface plate can be easily released from the mold. According to this construction, there can be obtained the ribs 34 each having a slope 34c as will be next explained with reference to FIG. 10.

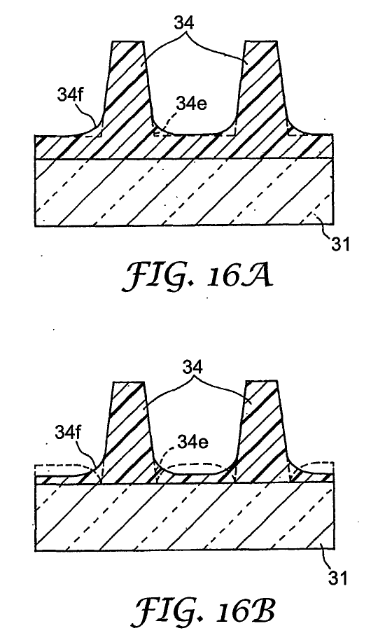

The groove 4 may be formed non-linearly at its boundary portion with the planar portion 11b of the molding layer 11 without describing an angle shown in FIG. 9. Though this non-linear profile is not particularly limited, it is preferably an R (chamfer) pattern. As shown in FIG. 15, for example, the groove 4 and the planar portion 11b in the molding layer 11 are preferably formed as a chamfer pattern 11f instead of an angled pattern 11e. When the chamfer pattern is imparted to the groove 4 as shown in this drawing, cracks at the root of the resulting ribs can be prevented as will be later explained with reference to FIG. 16. Such a construction is particularly effective for the grid-like rib pattern, and exposure of the electrodes can be prevented. To obtain this construction, a fillet is preferably applied to a predetermined position of a metal mold used for producing the mold.

One or more alignment marks are preferably applied in an arbitrary pattern to positions not exerting adverse influences on molding of the ribs, in the rib non-formation portion 18 of the molding layer 11.

The molding layer 11 is preferably formed of a cured product of a curable material. The curable material is either a heat-curable material or a photo-curable material. The photo-curable material is particularly useful because it does not need an elongated heating furnace for forming the molding layer and can be cured within a relatively short period of time. The photo-curable materials are preferably photo-curable monomers and oligomers and are further preferably acrylate type or methacrylate type monomers and oligomers. The curable material can contain additives. Suitable additives are a polymerization initiator (such as a photo-polymerization initiator) and an antistatic agent.

Examples of the acrylate type monomers for forming the molding layer, though not restrictive, are urethane acrylate, polyether acrylate, acrylamide, acrylonitrile, acrylic acid and acrylic acid ester. Examples of the acrylate type oligomers for forming the molding layer, though not restrictive, are urethane acrylate oligomer and epoxy acrylate oligomer. Urethane acrylate and its oligomer can provide soft and tough cured products after curing, have a relatively high curing rate among the acrylates in general, and can contribute to the improvement of productivity of the mold. When these acrylate type monomers and oligomers are used, the molding layer becomes optically transparent. Therefore, the flexible mold having such a molding layer is advantageous because it makes it possible to use a photo-curable molding material when the PDP ribs are produced. Incidentally, these acrylate type monomers and oligomers may be used either alone or in an arbitrary combination of two or more kinds. Though not hereby listed, the methacrylate type monomers and oligomers, too, include similar materials and can be employed in the same way.

The support 1 for supporting the molding layer 11 is not particularly limited, but is preferably transparent. When handling property and hardness are taken into consideration, the support 1 is preferably a film of a transparent plastic material. Examples of suitable plastic materials for the support are, though not restrictive, polyethylene terephthalate (PET), polyethylene naphthalate (PEN), stretched polypropylene, carbonate and triacetate. Among them, the PET film is useful for the support. For example, a polyester film such as Tetron™ film can be advantageously used as the support. These plastic films may be used as a single-layered film or as a composite or laminate film of two or more kinds. Primer maybe separately coated to improve bonding strength of the molding layer 11 to the support 1.

The plastic film or other support described above may be used in thickness of various values depending on the construction of the mold and the PDP. Generally, the thickness is within the range of from about 0.05 to about 1 mm and preferably from about 0.1 to 0.4 mm. When the thickness of the support is outside this range, handling property drops. A greater thickness of the support is advantageous for securing the strength.

The PDP back surface plate according to the invention is so constituted as to comprise a substrate, and a rib pattern layer formed on the substrate and including a rib region having a predetermined shape and a predetermined size and a rib non-formation region occupying at least a part of the peripheral portion of the rib region. It is important in the PDP back surface plate according to the invention that in the rib non-formation region of the rib pattern layer, a thin film made of the same material as that of the rib is formed to a predetermined thickness in the rib non-formation region of the rib pattern layer, whereas the rib or a rib-associated material does not exist in the back surface plate according to the prior art.

FIG. 10 is a perspective view schematically showing the PDP back surface plate 50 of the invention produced by using the flexible mold 10 shown in FIG. 9. FIG. 11 is a sectional view taken along a line XI-XI of the back surface plate shown in FIG. 10. As can be easily understood from these drawings, the ribs 34 formed in the rib formation region 36 correspond to the grooves 4 of the mold 10. A thin film 34b formed of the same material as that of the rib is formed between a rib 34 and its adjacent rib 34. In the case of this back surface plate 50, a rib pattern layer 34a having a predetermined thickness t is provided to a rib non-formation region 38. The rib pattern layer 34a is formed simultaneously with the formation of the ribs 34 and its thickness t corresponds to a decrement d of the thickness of the molding layer 11a in the rib non-formation portion 18 of the mold 10. In other words, the thickness t of the rib pattern layer 34a is generally at least about 5 μm, preferably within the range of 5 to 40 μm and further preferably within the range of about 10 to 15 μm.

Incidentally, in the PDP back surface plate 50 shown in FIGS. 10 and 11, the thin film 34b of the rib region 36 and the thin film (rib pattern layer) 34a of the rib non-formation region have the same thickness. However, they may have different thickness. In other words, the thickness of the thin film layer 34b may be greater than, or equal to, the thickness of the thin film 34a. Otherwise, the former may be smaller than the latter. Generally, the thin film 34 is preferably thinner than the thin film 34b. The thin film 34a needs to have only the function of covering the electrode of the rib non-formation region, and the thinner film leads to saving of the rib material.

Each rib 34 preferably has a slope 34c at its terminal portion. When design is so made as to provide the slope to the rib 34, the back surface plate can be easily released from the mold and breakage of the rib end portion can be prevented.

Alignment marks 38 are preferably provided to the rib non-formation region 38 in order to improve handling property, accuracy and production yield. The number, shape and size of the alignment marks 34m are not limited, but it is recommended to form the alignment marks at four corners of the rib non-formation region 38 at positions spaced apart by several centimeters from the ribs, for example. Besides the crisscross shape shown in the drawing, the shape of the alignment marks 34m may be round or linear. The size (height) of the alignment marks 34m is preferably equal to, or smaller than, the height of the rib 34 from the aspect of the molding operation though the alignment marks are shown by plane in the drawing to simplify illustration.

In the PDP back surface plate 50 shown in FIGS. 10 and 11, the root of each rib 34 can be improved to the shape shown in FIG. 16. In other words, if the root of the rib 34 linearly rises to give an angled pattern 34e as shown in FIG. 16(A), a disadvantage is likely to occur in that crack develops and an underlying electrode is exposed after firing as shown in FIG. 16(13). The probability of the occurrence of such a disadvantage is greater in the grid-like rib pattern (not shown) than in the straight rib pattern shown in FIG. 10.

In FIG. 16, a fillet (pad) 34f is applied to the root of each rib 34 so that the rise of the rib 34 does not describe an acute curve but applies a curve as shown in the drawing.

When the fillet 34f exists at the root of the rib 34, the disadvantage such as the occurrence of crack does not occur after firing of the rib as shown in FIG. 16(B). Incidentally, the rib 34 shown in the drawing can be advantageously produced by use of the mold shown in FIG. 15.

The flexible mold according to the present invention can be produced in accordance with various methods. Preferably, the flexible mold of the invention is advantageously produced by a method comprising the following steps:
a step of preparing a mold duplicating a surface form of the PDP back surface plate described above;
a step of applying a photo-curable material to a predetermined thickness to the surface of the mold to form a photo-curable material layer;
a step of laminating a transparent support formed of a plastic material further on the photo-curable material layer of the mold, thereby forming a laminate body of the mold, the photo-curable material layer and the support;
a step of irradiating rays of light to the laminate body from the support side to cure the photo-curable material layer;
a step of forming, through curing of the photo-curable material layer, a transparent molding layer having, on its surface, groove patterns necessary for duplicating the ribs in a rib formation portion corresponding to the rib region of the back surface plate, and a thickness necessary for forming a thin film formed of the same material as that of the ribs in a non-rib portion corresponding to the rib non-formation region of the back surface plate; and
a step of releasing the molding layer together with the support supporting the molding layer from the mold.

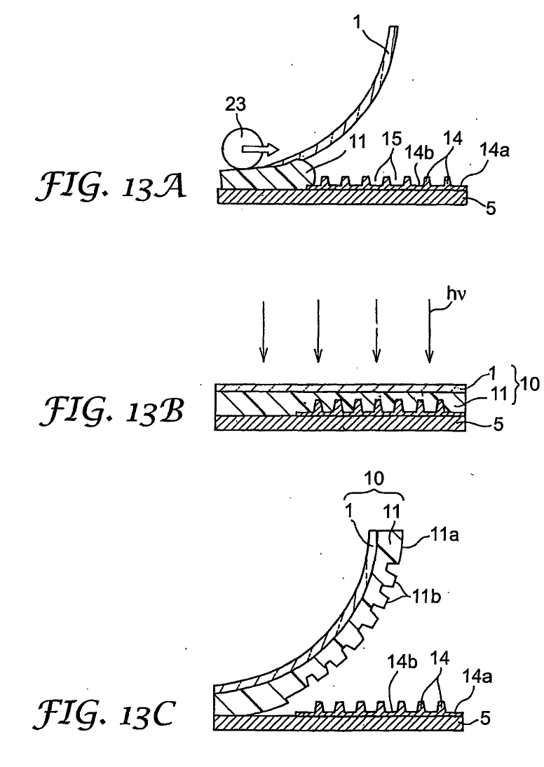

The flexible mold according to the invention can be advantageously produced in accordance with the process steps serially shown in FIG. 13, for example.

First, a mold (e.g. metal) 5 having a shape and a size corresponding to those of the PDP substrate as an object of production, a support 1 formed of a transparent plastic film (hereinafter called the “support film”) and a laminate roll 23 are prepared as shown in FIG. 13(A). The mold 5 has partitions 14 having the same pattern and the same shape as those of the ribs of the PDP back surface plate on a surface of its rib formation portion. Spaces (recess portions) defined by the adjacent partitions 14 are to later operate as discharge display cells of the PDP. Reduced thickness portions 14a corresponding to the thin film (rib pattern layer) of the resulting back surface plate are formed in the rib non-formation portion of the mold 5. The reduced thickness portions 14a are also formed as reduced thickness portions 14b between the partitions 14. A taper may be formed at the upper end of the partition 14 to prevent entrapment of bubbles. When the mold having the same shape as the final rib shape is prepared, a processing of the end portions of the ribs becomes unnecessary after the production of the ribs, and the occurrence of defect resulting from fragments generated by the end portion treatment can be suppressed. The laminate roll 23 is used to push the support film 1 to the mold 5, and is made of rubber. Other known/customary laminate means may be used in place of the laminate roll, whenever necessary. The support film 1 consists of a polyester film or other transparent plastic films described above.

Next, a predetermined amount of the photo-curable molding material 11 is applied to an end face of the mold 5 by use of known/customary coating means (not shown) such as a knife coater or a bar coater. When a soft material having flexibility is used for the support film 1, the support film 1 keeps adhesion with the photo-curable molding material 11 even when the latter undergoes shrinkage. Therefore, unless the support film undergoes deformation by itself, a dimensional change of 10 ppm or more does not occur.

To remove the dimensional change of the support film due to humidity, an aging treatment is preferably carried under a production environment of the mold before the laminate treatment. Unless this aging treatment is carried out, dimensional variance may occur in the resulting mold to such an extent that cannot be permitted (for example, variance in order of 300 ppm).

Next, the laminate roll 23 is allowed to slide on the mold 5 in a direction indicated by an arrow. As a result of this laminate treatment, the molding material 11 is uniformly distributed at a predetermined thickness and fills also the gaps of the partitions 14.

After the laminate treatment is completed, the rays of light (hν) are irradiated to the molding material 11 as indicated by arrows in FIG. 13(B) while the support film 1 is laminated on the mold 5. Here, if the support film 1 does not contain light scattering elements such as bubbles and is uniformly formed of the transparent material, the irradiated rays of light hardly attenuate but can uniformly reach the molding material 11. As a result, the molding material can be efficiently cured and forms the uniform molding layer 11 while adhering to the support film 1. In this way, the flexible mold 10 in which the support film 1 and the molding layer 11 are integrally bonded to each other can be obtained. Since this process step can use ultraviolet rays having a wavelength of 350 to 450 nm, there is the merit that a high-pressure mercury lamp such as a fusion lamp generating high heat need not be used as a light source. Since the support film and the molding layer are not caused to undergo thermal deformation during photo-curing, there is another merit that pitch control can be conducted highly precisely.

The flexible mold 10 is thereafter released from the mold 5 while keeping its integrity (support film 1+molding layer 11) as shown in FIG. 13(C). The flexible mold so obtained can be as such utilized for the production of the PDP back surface plate. To avoid the problem of mold shrinkage during use, however, the flexible mold 10 is preferably subjected to conditioning treatment. This treatment is carried out, for example, by placing the flexible mold into a thermostat tank in accordance with a predetermined schedule.

The flexible mold according to the invention can be produced relatively easily irrespective of its size provided that known and conventional laminate means and coating means are employed. Therefore, unlike the conventional production methods using vacuum equipment such as a vacuum press machine, the invention can easily produce a large flexible mold without any limitation.

The flexible mold according to the invention is useful for shaping the ribs of the PDP having the straight rib pattern, the grid rib pattern or other patterns. When this flexible mold is used, a PDP having a large screen and a rib structure in which ultraviolet rays do not easily leak from the discharge display cells to the outside can be easily produced by merely using the laminate roll in place of vacuum equipment and/or a complicated process.

The production method of the PDP back surface plate according to the invention preferably comprises the following steps:
a step of producing the flexible mold by the method of the invention described above;
a step of arranging a curable molding material between the substrate and the molding layer of the mold, thereby charging the molding material into the groove pattern of the rib formation portion of the mold and applying it to a predetermined thickness to the rib non-formation portion;
a step of curing the molding material, thereby forming a PDP back surface plate comprising a substrate and a rib pattern layer formed on the substrate and having a rib region including ribs having a predetermined shape and size and a non-rib region occupying at least a part of the periphery of the rib region, the non-rib region having a thin film of a predetermined thickness and formed of the same material as that of the ribs; and
a step of releasing the back surface plate from the mold.

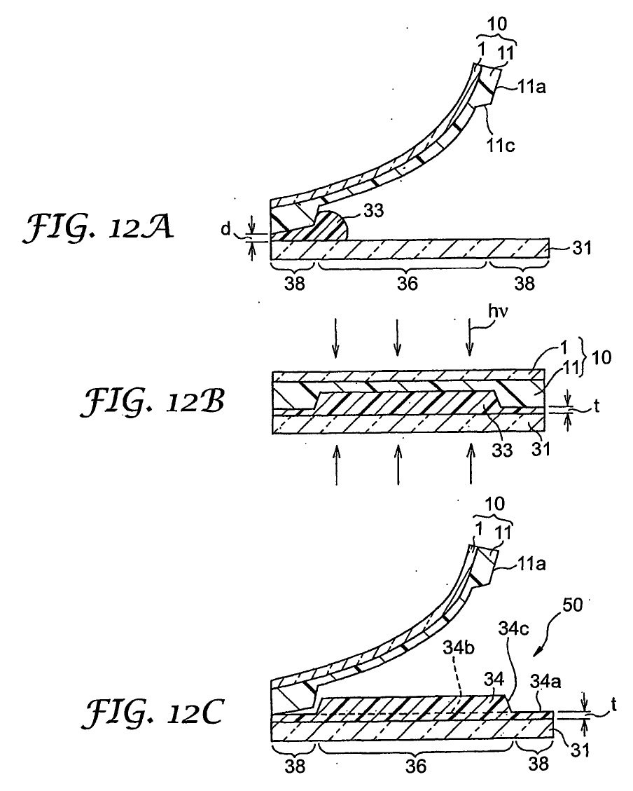

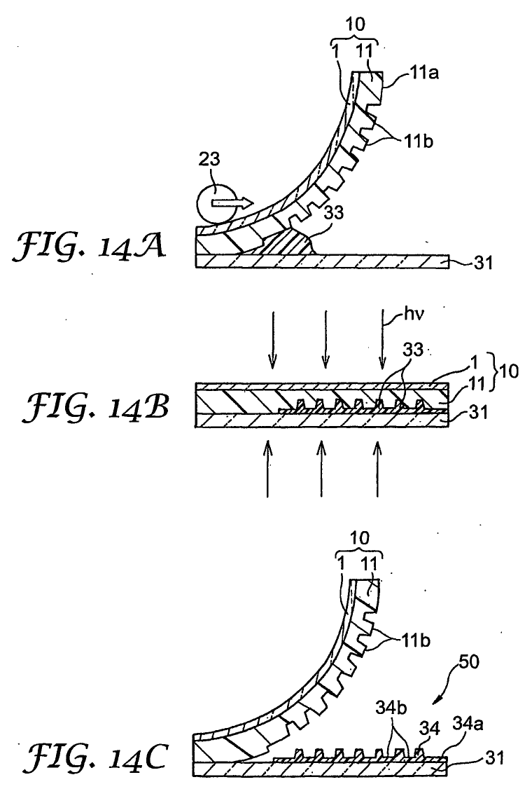

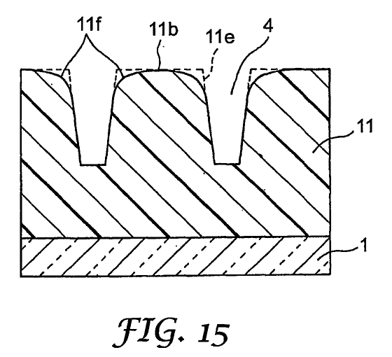

Though the PDP back surface plate of the invention can be produced in accordance with various methods, it can be generally and advantageously produced by means serially shown in FIG. 12. Incidentally, production of the back surface plate having the straight rib pattern shown in FIGS. 10 and 11 will be explained with reference to the sectional view when the ribs are viewed from the transverse direction. The detail of a rib precursor and the like used in this production method will be explained in a later-appearing production method with reference to FIG. 14.

First, a glass substrate 31, the flexible mold 10 of the invention and a predetermined rib precursor 33 necessary for forming ribs are prepared as shown in FIG. 12(A). The glass substrate 31 includes a rib region 36 and a non-rib region 38 around the rib region 36. The flexible mold 10 includes a transparent support 1 and a molding layer 11 having groove patterns for forming the ribs and formed on the support 1. The groove pattern for forming the ribs is not applied to the non-rib portion 11a of the molding layer 11, and its surface is recessed by a depth d from the surface (not shown) of the rib formation portion so that a gap d can be formed when the mold 10 is laminated to the glass substrate 31. An end face of the rib non-formation portion 11a has a slope 11c so as to impart an inclined end face to the resulting ribs. Furthermore, the rib precursor 33 is generally composed of a photo-curable resin of an acrylate or methacrylate type.

Next, the mold 10 is placed at a predetermined position on the glass substrate 31 as shown in the drawing, and the rib precursor 33 is supplied onto the glass substrate 31. The mold 10 is laminated to the glass substrate 31 in such a fashion that the rib precursor 33 attains a uniform thickness and fills the groove pattern of the mold 10. This laminate operation can be executed advantageously by use of a laminate roll but other laminate means may be used, too, whenever necessary. There is thus obtained a laminate body of the glass substrate 31 and the mold 10 as shown in FIG. 12(B).

Subsequently, the rib precursor 33 is cured. Since the photo-curable resin is used hereby as the rib precursor, the laminate body of the glass substrate 31 and the mold 10 is placed into a light irradiation apparatus (not shown) and the rays of light for inducing curing of the photo-curable resin are irradiated to the rib precursor 33 through the glass substrate 31 and the mold 10. The rib precursor 33 is thus cured, and ribs 34 shown in FIG. 12(C) can be obtained.

After the ribs 34 are formed, the mold 10 is peeled and removed from the glass substrate 31 as shown in FIG. 12(C). Since the mold 10 has flexibility and excellent handling property, the mold 10 can be easily removed with limited force without breaking the ribs 34 fixed to the glass substrate 31. In the PDP back surface plate 50 so obtained, a rib pattern 34a of a thin film firmly fixed to the glass substrate 31 is formed in the non-rib region 38 adjacent to the rib region 36 having the ribs 34 in such a fashion as to correspond to the rib non-formation portion 11a of the mold 10. The rib pattern layer 34a extends between the adjacent ribs 34 and forms a thin film 34b. The terminal portion of each rib 34 has a slope 34c corresponding to the slope 11c of the mold 10.

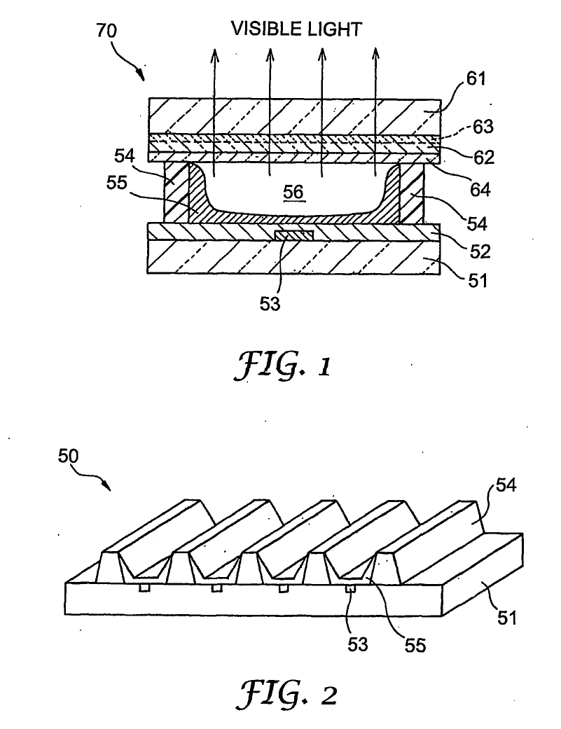

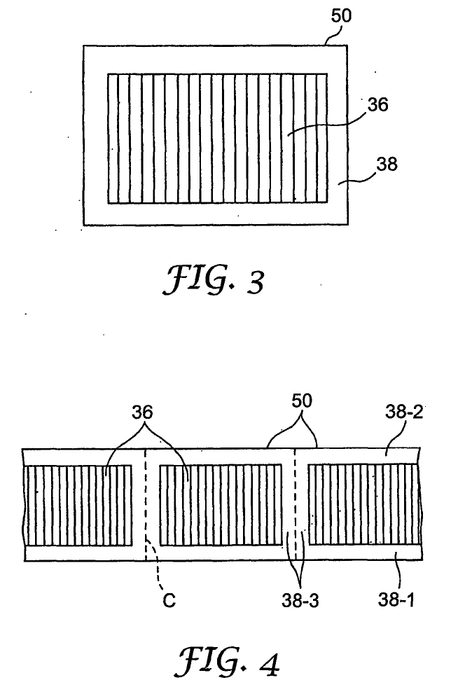

In order to explain in further detail the production method of the PDP back surface plate according to the invention, FIG. 14 is referred to. The production method shown in this drawing uses the flexible mold 10 produced by the method explained previously with reference to FIG. 13. To execute this production method, a production apparatus shown in FIGS. 1 to 3 of Japanese Unexamined Patent Publication (Kokai) No. 2001-191345 can be advantageously used, for example.

First, a transparent glass substrate having a plurality of electrodes arranged in parallel with, and spaced apart by a predetermined gap from, one another is prepared and is set to a stool. Next, the flexible mold 10 of the invention having the groove pattern on its surface is placed at a predetermined position on the glass substrate 31 as shown in FIG. 14(A), and positioning (alignment) between the glass substrate 31 and the mold 10 is conducted. Since the mold 10 is transparent, positioning with the electrodes on the glass substrate 31 can be easily made. More specifically, this positioning is made with eye observation or by use of a sensor such as a CCD camera so that the grooves of the mold 10 are parallel to the electrodes of the glass substrate 31. Alternatively, positioning may be carried out by utilizing the alignment marks put to the rib non-formation portion of the mold 10 not shown in the drawing. At this time, the temperature and the humidity may be adjusted so as to bring the grooves of the mold 10 into conformity with the gap between the adjacent electrodes on the glass substrate 31. Generally, both mold 10 and glass substrate 31 undergo extension and contraction in accordance with the change of the temperature and the humidity, and the degree of extension and contraction is different between them. Therefore, after positioning of the glass substrate 31 and the mold 10 is completed, the temperature and the humidity are controlled to keep the values at that time. Such a control method is useful particularly for producing a PSP substrate having a large area

Subsequently, the laminate roll 23 is placed on one of the end portions of the mold 10. The laminate roll 23 is preferably a rubber roll. At this time, one of the ends of the mold is preferably fixed onto the glass substrate 31. For, a positioning error of the glass substrate 31 and the mold 10 that has already been attained can be prevented.

Next, the other free end portion of the mold 10 is lifted up by use of a holder (not shown) and is moved above the laminate roll 23 so as to expose the glass substrate 31. At this time, caution must be paid lest tension is applied to the mold 10. This is to prevent the occurrence of crease in the mold 10 and to keep positioning between the mold 10 and the glass substrate 31. Other means may be used so long as this positioning can be maintained. Incidentally, since the mold 10 has flexibility in the production method of the invention, the mold 10 can be accurately returned to the original positioning state during the subsequent laminate operation even when it is pulled up as shown in the drawing.

Subsequently, a predetermined amount of the rib precursor necessary for forming the ribs is supplied onto the glass substrate 31. A paste hopper equipped with a nozzle, for example, can be used for supplying the rib precursor.

Here, the term “rib precursor” means a molding material that can finally form the intended ribs (rib moldings), and is not particularly limited so long as the rib moldings can be formed. The rib precursor may be either of a heat-curing type or of a photo-curing type. The photo-curable rib precursor, in particular, can be used extremely effectively when used in combination with the transparent flexible mold described above. As described above, the flexible mold hardly involves the defect such as bubbles and deformation, and can suppress irregular scattering of the rays of light. Therefore, the molding material can be uniformly cured and ribs having predetermined high quality can be produced.

An example of a composition suitable for the rib precursor is the one that basically contains (1) a ceramic component for imparting the rib shape, such as aluminum oxide, (2) a glass component for filling the gaps between the ceramic components and imparting compactness to the ribs such as lead glass or phosphate glass and (3) a binder component for accommodating and holding the ceramic components and bonding them together, and its curing agent or a polymerization initiator. Curing of the binder component is preferably attained by irradiation of light but not by heating or temperature elevation. In such a case, thermal deformation of the glass substrate need not be taken into consideration. An oxidation catalyst consisting of an oxide, salt or complex of chromium (Cr), manganese (Mn), iron (Fe), cobalt (Co), nickel (Ni), copper (Cu), zinc (Zn), indium (In) or tin (Sn), ruthenium (Ru), rhodium (Rh), palladium (Pd), silver (Ag), iridium (Ir), platinum (Pt), gold (Au) or cerium (ce) may be added to the composition to lower a removing temperature of the binder component.

To improve the bonding strength of the rib precursor to the glass substrate, primer may be in advance applied to the glass substrate.

To execute the production method shown in the drawing, the rib precursor 33 is not uniformly supplied to the entire portion on the glass substrate 31. The rib precursor 33 needs be supplied to only the glass substrate 31 in the proximity of the laminate roll 23 as shown in FIG. 14(A). For, when the laminate roll 23 moves on the mold 10 in the subsequent step, the rib precursor 33 can be uniformly spread on the glass substrate 31. In such a case, however, the rib precursor 33 has a viscosity of generally about 20,000 cps or below, and preferably about 5,000 cps or below. When the viscosity of the rib precursor is higher than about 20,000 cps, the laminate roll cannot easily spread the rib precursor, so that air is entrapped into the grooves of the mold and may result in the defect of the ribs. As a matter of fact, when the viscosity of the rib precursor is about 20,000 cps or below, the rib precursor can be uniformly spread between the glass substrate and the mold when the laminate roll is moved only once from one of the ends to the other of the glass substrate, and can uniformly fill all the grooves without entrapping the bubbles. However, the supplying method of the rib precursor is not limited to the method described above. For example, the rib precursor may be coated to the entire surface of the glass substrate, though it is not shown in the drawing. At this time, the rib precursor for coating has the same viscosity as described above. Particularly when the ribs of the grid pattern are formed, the viscosity is about 20,000 cps or below and preferably about 5,000 cps or below.

Next, a rotary motor (not shown) is driven and the laminate Toll 23 is moved at a predetermined speed on the mold 10 as indicated by an arrow in FIG. 14(A). While the laminate roll 23 moves on the mold 10, a pressure is serially applied from one of the ends to the other of the mold 10 due to the weight of the laminate roll 23. The rib precursor 33 spreads between the glass substrate 31 and the mold 10, and the molding material is filled into the grooves of the mold 10. In other words, the rib precursor 33 serially replaces air of the grooves and fills them. At this time, the thickness of the rib precursor can be adjusted to several microns to dozens of microns when the viscosity of the rib precursor, the diameter and weight of the laminate roll or the moving speed is suitably controlled.

In the production method shown in the drawing, even when the grooves of the mold operate as the channel of air and collect air, air can be efficiently discharged outside or to the periphery of the mold when the pressure is applied as described above. As a result, this production method can prevent the bubbles from remaining even when filling of the rib precursor is conducted at the atmospheric pressure. In other words, it is not necessary to reduce the pressure when filling the rib precursor. Needless to say, the bubbles can be removed more easily in vacuum.

Subsequently, the rib precursor is cured. When the rib precursor spread on the glass substrate 31 is of the photo-curable type, the laminate body of the glass substrate 31 and the mold 10 is placed into a light irradiation apparatus (not shown) as shown in FIG. 14(B), and the rays of light such as ultraviolet rays (UV) are irradiated to the rib precursor 33 through the glass substrate 31 and the mold 10 to cure the rib precursor 33. In this way is obtained a molding of the rib precursor, that is, the rib itself.

Finally, while the resulting ribs 34 are kept bonded to the glass substrate 31, the glass substrate 31 and the mold 10 are withdrawn from the light irradiation apparatus, and the mold 10 is then peeled and removed as shown in FIG. 14(C). Since the flexible mold 10 according to the invention is superior in the handling property, the mold 10 can be easily peeled and removed with limited force without breaking the ribs 34 bonded to the glass substrate 31 when a material having low adhesion is used for the coating layer of the mold. Needless to say, a large apparatus is not necessary for this peeling and removing operation.

In the PDP back surface plate 50 so obtained, a rib pattern layer 34a of a thin film fixed to the glass substrate 31 is formed in the non-rib region adjacent to the rib region having the ribs 34 in such a fashion as to correspond to the rib non-formation portion of the mold 10 as shown in the drawing. A thin film 34b is also formed in such a fashion as to correspond to the planar portion 11b disposed in the rib formation portion of the mold 10.

When the flexible mold, the PDP back surface plate and their production methods according to the invention described above are applied to the production of the PDP, many problems that have not been solved by the prior art technologies can be solved. For example, because the ribs need be formed only at the necessary portions of the back surface plate, a complicated step of forming the ribs in unnecessary portions and removing them in a subsequent step can be eliminated. Therefore, fragments of the ribs during the removal of the unnecessary ribs do not occur. Because the ribs do not exist in the non-rib region, the sealant can be easily applied when the back surface plate and the front surface plate are superposed and sealed with each other in a subsequent step.

Curing of the rib precursor can be carried out collectively in the rib region and the non-rib region when forming the ribs. It is therefore possible to prevent the uncured rib precursor from adhering to the mold and hence to use repeatedly the mold without calling for the scraping work of the adhering mater by use of a scraper. Because the rib precursor is cured in the rib region and the non-rib region and can adhere to the glass substrate, breakage of the cured rib precursor can be prevented when mold is peeled from the finished back surface plate.

The rib pattern layer is formed in the thin film form in the non-rib region of the PDP back surface plate, too. Therefore, the electrode portion can be reliably protected without coating the dielectric layer (electrode protecting layer) as has been made in the prior art, and disconnection during firing of the ribs can be prevented. Further, because the inclination can be applied to the rib end portion, it is possible to avoid the problem that the rib undergoes shrinkage during firing and its end portion turns up.

The invention will be explained with the following examples. It would be obvious to those skilled in the art that the invention is not particularly limited to the following examples.

### EXAMPLE 1

Production of Flexible Mold:

A rectangular mold having ribs (partitions) of a straight pattern is prepared to produce a PDP back surface plate. More particularly, this mold has a rib portion having the ribs and a non-rib portion defining the periphery of the rib portion. Ribs having an isosceles trapezoidal section are arranged in a predetermined pitch in a longitudinal direction of the rib portion. Spaces (recesses) defined by adjacent ribs correspond to discharge display cells of the PDP. Each rib has a height of 135 μm, a top width of 60 μm, a bottom width of 120 μm and a pitch (distance between the centers of adjacent ribs) of 300 μm. The number of ribs is 3,000. A total pitch of the ribs (distance between the centers of ribs at both ends) is 900.221 mm. The thickness of the non-rib portion (corresponding to the thickness of the rib pattern layer to be formed in the non-rib region of the resulting back surface plate) is about 20 μm.

To form the molding layer of the mold, a photo-curable resin is prepared by mixing 99 wt-% of aliphatic urethane acrylate oligomer, (product of Dicell UCB Co.) and 1 wt-% of 2-hydroxy-2-methyl-1-phenyl-propane-1-on, commercially available from Ciba Specialties Chemical Co. under the trade designation “Darocure 1173”.

A PET film, commercially available from Teijin Co. under the trade designation “HPE188” wound on a roll and having a thickness of 188 μm is prepared as a support of the mold.

The photo-curable resin described above is applied in a line form to the upstream side of the mold so prepared. Next, the PET film is laminated in such a fashion as to cover the surface of the mold. When the PET film is sufficiently pushed by use of a laminate roll, the photo-curable resin is filled into the recesses of the mold.

The rays of light having a wavelength of 300 to 400 nm are irradiated to the photo-curable resin for 30 seconds through the PET film by use of a fluorescent lamp, a product of Mitsubishi Denki-Oslam Co. The photo-curable resin is cured to give a molding layer. Subsequently when the PET film is peeled from the mold together with the molding layer, there is obtained a flexible mold having a shape and a size corresponding to those of the ribs of the mold, and having a large number of grooves.

Production of PDP Back Surface Plate:

After the flexible mold is produced in the manner described above, the mold is positioned to, and arranged on, a PDP glass substrate. The groove pattern of the mold is so arranged as to oppose the glass substrate. Next, a photosensitive ceramic paste is filled between the mold and the glass substrate. The ceramic paste used in this case has the following composition.

Photo-Curable Oligomer:

bis-phenol A diglycidyl methacrylate acid adduct (product of Koeisha Kagaku K. K.) 21.0 g

Photo-Curable Monomer:

triethyleneglycol dimethacrylate (product of Wako Junyaku Kogyo K. K.) 9.0 g

Diluent:

1,3-butanediol (product of Wako Junyaku Kogyo K. K.) 30.0 g

Photo-Initiator:

bis(2,4,6-trimethylbenzoyl)-phenylphosphine oxide (commercially available from Ciba Specialties Chemicals Co. under the trade designation “Irgacure 819”) 0.3 g

Surfactant:

phosphate peroxyalkylpolyol 3.0 g

Inorganic Particle:

mixed powder of lead glass and ceramic (product of Asahi Glass Co. 180.0 g

After filling of the ceramic paste is completed, the mold is laminated in such a fashion as to cover the surface of the glass substrate. When the mold is carefully pushed by use of a laminate roll, the ceramic paste is completely filled into the grooves of the mold.

Under this state, the rays of light having a wavelength of 400 to 500 nm are irradiated from both surfaces of the mold and the glass substrate by use of a fluorescent lamp of Philips Co. The ceramic paste is cured to give the ribs. Subsequently, the mold is removed from the glass substrate and the intended PDP back surface plate consisting of the glass substrate having the ribs is obtained. In the resulting back surface plate, the rib pattern layer is uniformly formed to a thickness of about 20 μm in the non-rib region not having the ribs. When the mold is removed from the glass substrate, fragments of the ceramic paste used for forming the ribs and dust do not occur.

Subsequently, the glass substrate is heat-treated at 550C. for 1 hour to fire the ribs. The problem of the terminal portion of the ribs turning up from the glass substrate does not occur. The terminal portion of the ribs keeps a gentle taper shape.

### COMPARATIVE EXAMPLE 1

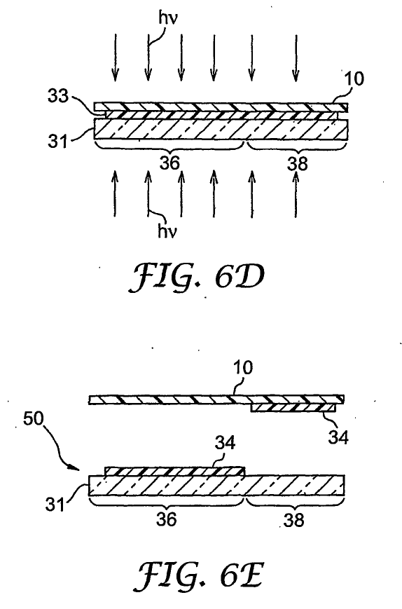

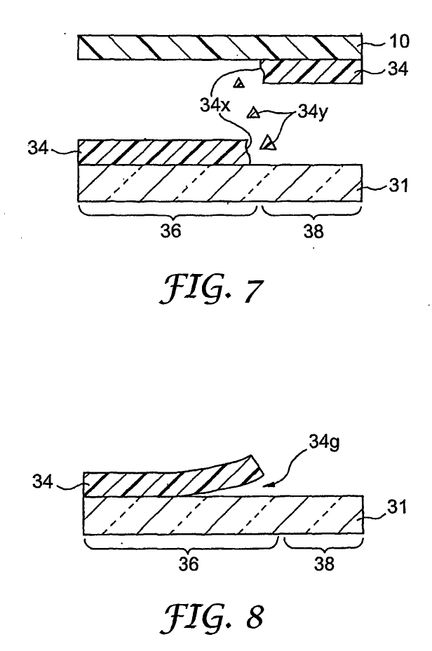

The procedures of Example 1 are repeated but in this Comparative Example, the PDP back surface plate is produced by the method previously explained with reference to FIGS. 5 and 6 for comparison.

The ceramic paste is filled between the glass substrate and the mold prepared in the same way as in Example 1. Next, a shading mask having the same pattern as that of the center portion of the mold (rib formation portion) is put on the center portion. Thereafter, the rays of light having a wavelength of 300 to 400 nm are irradiated to the ceramic paste for one minute through the mold. A fluorescent lamp of Mitsubishi Denki-Oslam Co. is used as a light source. The ceramic paste of the non-rib region of the glass substrate is thus cured selectively.

Subsequently, the shading mask is removed from the mold and the rays of light having a wavelength of 400 to 500 nm are irradiated for one minute from both surfaces of the mold and the glass substrate. A fluorescent lamp of Philips Co. is used as a light source. The uncured ceramic paste existing between the mold and the glass substrate is cured to give the ribs.

The mold is then removed from the glass substrate. In the mold, the cured ceramic paste remains integrally adhered to its rib non-formation region. On the other hand, the ribs are firmly bonded to the rib region of the glass substrate. It is thus confirmed that the intended PDP back surface plate is acquired.

In this example, however, breakage occurs in the interface between the rib region and the non-rib region in the cured ceramic layer when the mold is removed from the glass substrate, and fragments of the ceramic paste occur. The fragments adhere to the rib region and cannot be removed. In the non-rib region of the glass substrate, the electrodes remain exposed. Furthermore, when the glass substrate is fired at 550° C. for one hour to cure the ribs, the problem that the terminal portion of the ribs turns up from the glass substrate occurs.

1. A flexible mold for producing a PDP back surface plate including a rib region having ribs having a predetermined shape and a predetermined size and a non-rib region occupying at least a part of a peripheral portion of said rib region, comprising:
a support and a molding layer disposed on said support;
wherein said molding layer is equipped on a surface thereof with groove patterns necessary for duplicating ribs having a predetermined shape and a predetermined size in a rib formation portion corresponding to said rib region of said back surface plate; and in a rib non-formation portion corresponding to a non-rib region of said back surface plate, said molding layer is formed to a thickness necessary for forming a thin film made of the same material as that of said ribs in said rib non-formation region.

2. A flexible mold as defined in claim 1, wherein said support and said molding layer are transparent.

3. A flexible mold as defined in claim 1, wherein said molding layer is equipped in said rib region with a portion necessary for forming a thin film made of the same material as that of said ribs between adjacent ribs.

4. A flexible mold as defined in claim 1, wherein inclination is applied to a terminal portion of each of said groove patterns in said molding layer.

5. A flexible mold as defined in claim 1, wherein corners are removed from an upper end portion of a sidewall of said groove pattern.

6. A flexible mold as defined in claim 1, wherein said molding layer further includes alignment marks applied to said rib non-formation portion.

7-19. (canceled)

20. A PDP back surface plate comprising a substrate having formed thereon a rib pattern layer having a rib region having ribs having a predetermined shape and a predetermined size and a non-rib region occupying at least a part of a peripheral portion of said rib region, wherein a thin film made of the same material as that of said ribs is formed to a predetermined thickness in said non-rib region.

21-34. (canceled)
